(19) United States
(12) Patent Application Publication
(10) Pub. No.: US 2016/0131916 A1
(43) Pub. Date: May 12, 2016

(54) DEVICE AND METHOD FOR GENERATING A SPATIAL DEPTH EFFECT OF IMAGE INFORMATION PRESENT IN A 2D IMAGE AREA

(71) Applicant: Roland WOLF, Beinwil am See (CH)

(72) Inventor: Roland WOLF, Beinwil am See (CH)

(21) Appl. No.: 14/896,921

(22) PCT Filed: May 28, 2014
(86) PCT No.: PCT/EP2014/001430

§ 371 Date: Dec. 8, 2015

(30) Foreign Application Priority Data
Jul. 1, 2013 (EP) 13003326.9

(51) Int. Cl. G02B 27/22; G02B 27/00; G02B 1/11

(52) U.S. Cl. CPC G02B 27/22; G02B 1/11; G02B 27/0081

(57) ABSTRACT

Apparatus and method for producing a spatial depth effect of an image information item present in a 2D image surface. The apparatus has a viewing bezel having an opening, wherein the viewing bezel has a boundary delimiting a viewing field and the opening forms the viewing field. In addition, the apparatus has a 2D image surface which is arranged at a distance behind the viewing bezel. With appropriate use of the apparatus, as viewed from a viewing position, the viewing bezel conceals the external boundary of the 2D image surface and, if appropriate, a frame element connected radially outwardly to the external boundary. The distance between the boundary of the viewing bezel delimiting the viewing field and the 2D image surface arranged behind it, is at least approximately constant. The distance between the boundary of the viewing bezel delimiting the viewing field and the 2D image surface arranged behind it is approximately 4% to approximately 20% of a greatest extent, in particular a diagonal, of the 2D image surface.

The present invention relates to an apparatus and a method for producing a spatial depth effect according to patent claims 1 and 10, respectively.

Document WO 2012/042111 A1 discloses an apparatus and a method for producing a spatial depth effect, wherein a viewing bezel for a 2D image surface is arranged at a distance of between 1% and 3% of the diagonal of the 2D image surface. A distance of more than 3% is not recommended. Rather, for an optimal effect, the distance is more likely to be restricted to 1.5% to 2.5% of the diagonal of the 2D image surface.

Document GB 2 467 847 A discloses an apparatus for producing a spatial depth effect, wherein a viewing bezel is removably secured on the TV apparatus using a securing means at a constant distance of 50 mm from a display of a TV apparatus. The distance of 50 mm is said to bring about the same effect for all sizes of displays, with no provision being made for a greater or smaller distance than 50 mm.

Document JP S54 68113 A discloses an apparatus for producing a spatial depth effect, wherein a viewing bezel is arranged—independently of the size of the display—at a distance of between 1 and 5 cm from a display.

WO 2010/094269 A2 discloses a display viewing apparatus for a display device. The viewing apparatus comprises a front wall having a viewing opening, constructed in the shape of a frame, with the front wall being securable removably on the display device using a securing device. In order to achieve spatial image perception of the images displayed on the display for a viewing position, the lateral boundary of the display device must be concealed by the frame-shaped region of the front wall, and the front wall of the viewing apparatus must also be curved concavely or convexly with respect to the flat display.

When viewed from a viewing position, the concave and the convex curvature of the front wall with respect to the flat display causes the curvature of the front wall and also the flat image surface arranged behind the curved front wall to be perceived, thereby inducing in the viewer stereopsis corresponding to the spatial image perception.

It is generally known that in the case of stereopsis, the brain must process two different images, which is associated with a learning effect to be able to recognize the spatial image perception. This can result in symptoms of fatigue and resulting headaches for the user of the viewing apparatus. For this reason, the display viewing apparatus according to WO 2010/094269 A2 can be moved from the viewing position into a rest position for switching off the stereopsis or for transport, with the front wall in the rest position lying directly against the flat display.

DE 10 2005 056 873 A1 and WO 2008/052527 A2 each disclose a viewing apparatus, in which a front wall having a viewing opening is configured to be flat or slightly curved and, in order to achieve spatial image perception, the image surface arranged behind it must be configured to be curved convexly, away from the viewer.

DE 203 17 862 U1 likewise discloses a viewing apparatus, in which an image surface, which is arranged behind a front wall having a viewing opening, is configured to be convexly curved, away from the viewer, wherein this document teaches that, in order to further increase the spatial image perception, the front wall must be configured to be concave, toward the viewer.

Consequently, the documents mentioned above teach that spatial image perception is possible only when the front wall and/or the image surface arranged behind the front wall has a curved configuration, so as to achieve the desired effect according to the principle of stereopsis, but at the risk of the viewer of the viewing apparatuses experiencing the abovementioned disadvantages with corresponding use.

It is therefore an object of the present invention to provide an apparatus and a method which produce a spatial depth effect of an image information item present in a 2D image surface, without physically impairing the user during proper use of the apparatus or the method.

The object is achieved by the apparatus and the method according to patent claims 1 and 10, respectively.

The apparatus according to patent claim 1 for producing a spatial depth effect of an image information item present in a 2D image surface has a viewing bezel having an opening, wherein the viewing bezel has a boundary delimiting a viewing field and the opening forms the viewing field. In addition, the apparatus has a 2D image surface, which is arranged at a distance behind the viewing bezel and is delimited at the periphery by an external boundary, wherein the 2D image surface is larger than the opening of the viewing bezel. With appropriate use, the viewing bezel covers, as viewed from a viewing position, the external boundary of the 2D image surface and, if appropriate, a frame element connected radially outwardly to the external boundary. The distance between the boundary of the viewing bezel delimiting the viewing field and the 2D image surface arranged behind it is at least approximately constant.

Owing to the approximately constant distance between the boundary of the viewing bezel delimiting the viewing field and the 2D image surface arranged behind it, it is no longer possible, as viewed from the viewing position, to capture the precise location of the 2D image surface. Correspondingly, what is known as a detached space in front of the viewing bezel in the direction of the 2D image surface is formed while factoring in the image information item from the 2D image surface, as a result of which a spatial depth effect is imparted on the viewer, as viewed from the viewing position.

The effect of the apparatus and of the method according to the invention can be explained by the fact that, by reversing the principle underlying a pinhole camera, the spatial depth effect as viewed from the viewing position in front of the viewing bezel in the direction of the 2D image surface is produced when the distance between the boundary delimiting the viewing field and the 2D image surface is at least approximately constant.

In this context, it should be noted that the detached space produced, as viewed from the viewing position, in front of the viewing bezel in the direction of the 2D image surface is not comparable to the image perception according to the principle of stereopsis, because in the present invention, the 2D image surface is not perceived by the viewer, such that the brain of the viewer does not need to process double images, as is the case with the present viewing apparatus according to the prior art which has a front wall which is curved concavely or convexly with respect to the flat display.

Instead, the desired effect occurs automatically using the apparatus or the method according to the invention as soon as the boundary of the viewing bezel delimiting the viewing field has the defined distance from the 2D image surface.

For this reason, a viewer who only has a single functioning eye and for whom therefore only monoscopic viewing is possible can likewise perceive said detached space in front of the viewing bezel in the direction of the 2D image surface.

The image information item is preferably present on the entire 2D image surface up to the outer boundary of the 2D image surface.

In the present invention, it is also possible to completely dispense with auxiliary aids, be it in electronic form or in the form of a special pair of spectacles as in conventional viewing apparatuses for 3D use, for example for viewing a 3D movie, because the spatial depth effect occurs as soon as the boundary of the viewing bezel delimiting the viewing field has the defined distance from the 2D image surface.

A further advantage according to the present invention is the fact that the spatial depth effect corresponds to the resolution of the image information item present in the 2D image surface, i.e. there is no loss in resolution or color representation.

It should moreover be noted at this point that the viewing bezel is made of an opaque material. As viewed from the viewing position, this produces the viewing field formed by the opening in the direction of the 2D image surface. Only the see-through part of the viewing bezel, that is to say the opening in the viewing bezel, permits view of an image section on the 2D image surface stored with the image information item. The opaque external boundary of the viewing bezel, by contrast, covers the external boundary of the 2D image surface and, if appropriate, the frame element connected radially outwardly to the external boundary.

According to the present invention, the distance between the boundary of the viewing bezel delimiting the viewing field and the 2D image surface arranged behind it is approximately 4% to approximately 20% of a greatest extent, in particular a diagonal, of the 2D image surface.

In one preferred embodiment, the distance is approximately 8% to approximately 15%, of the greatest extent of the 2D image surface.

The distance is preferably approximately 10% of the greatest extent of the 2D image surface.

The boundary of the viewing bezel delimiting the viewing field is preferably located on one plane. Owing to the approximately constant distance between the boundary of the viewing bezel delimiting the viewing field and the 2D image surface arranged behind it, the perception, as viewed from the viewing position, of separate double images, as mentioned in the introductory part relating to the prior art, is prevented.

In one preferred embodiment, the 2D image surface has a flat configuration. This embodiment also prevents the perception of separate double images when using the apparatus according to the invention.

The boundary of the viewing bezel delimiting the viewing field and the 2D image surface are preferably arranged such that they are parallel with respect to one another. What is particularly preferred here is that the boundary of the viewing bezel delimiting the viewing field and located on one plane faces the viewing position.

In one preferred embodiment, the opening, in particular that of the boundary of the viewing bezel delimiting the viewing field, and the external boundary of the 2D image surface are similar in terms of their shape. The term similar in this context is used in the mathematical sense and is intended to express that the geometric shape of the opening, in particular of the boundary of the viewing bezel delimiting the viewing field, is convertible to the geometric shape of the external boundary of the 2D image surface by scaling.

The opening of the viewing bezel is preferably covered with a transparent material. Using the transparent material it is possible to protect the 2D image surface arranged behind the viewing bezel against external influences.

In one particularly preferred embodiment, the transparent material is a glass pane. The glass pane can in this case be inserted into the opening of the viewing bezel or may be the viewing bezel itself.

In the case where the viewing bezel itself is the glass pane, a viewing-field delimiting portion of the glass pane must be provided with an opaque material, in particular a covering varnish, such that the view onto the external boundary of the 2D image surface and, if appropriate, the frame element which is connected radially outwardly to the external boundary is prevented.

The glass pane can with particular preference have antireflective coatings on both sides so as to avoid reflections on the glass pane from the 2D image surface or the environment.

It should be noted at this point that the present invention is particularly well-suited for a “depth illusion” in the sense of a typical view from a window into the distance, specifically when used in bright spaces, in particular with daylight and artificial light.

The apparatus or the method according to the invention preferably is employed in particular in small to large appliances and in small to very large systems, such as for example mobile phones, mobile tablets, TV apparatuses, theaters, and large halls.

Further advantages and properties of the apparatus or the method according to the invention can be gathered from the following description of an exemplary embodiment, which is explained with reference to the drawing.

In purely schematic form:

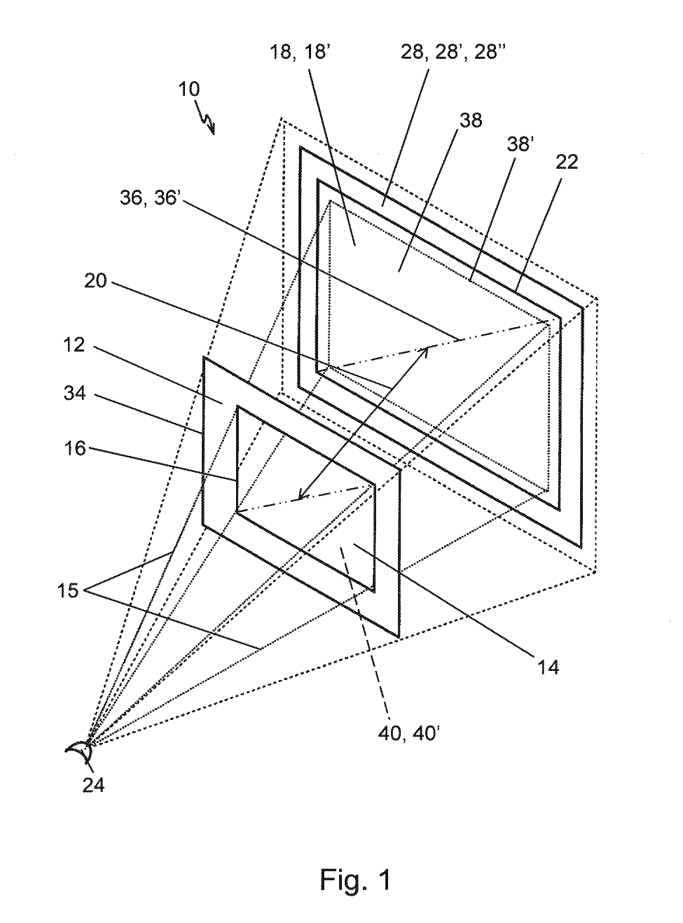

FIG. 1 shows an exploded view of an apparatus according to the invention having a viewing bezel with an opening and a 2D image surface, which is arranged at a distance behind the viewing bezel and is delimited at the periphery by an external boundary.

The apparatus 10 illustrated in FIG. 1 for producing a spatial depth effect has a frame-type viewing bezel 12 having an opening 14 which is, in the present case, rectangular. The viewing bezel 12 has a boundary 16 delimiting a viewing field 15, and the opening 14 forms the viewing field 15.

It should be noted at this point that the shape of the opening 14 in the viewing bezel 12 can be configured to be in particular that of the boundary 16 of the viewing bezel 12 delimiting the viewing field 15 and any other shape, for example circular or elliptical.

The frame-type viewing bezel 12 is made of an opaque material. For better illustration, the viewing bezel 12 in FIG. 1 is depicted purely schematically so as to illustrate better the principle of the present invention.

Arranged behind the viewing bezel 12 is, at an at least approximately constant distance 20, a 2D image surface 18. The 2D image surface 18 is delimited at the periphery by an external boundary 22. In addition, the 2D image surface 18 is larger than the boundary 16 of the viewing bezel 12 delimiting the viewing field 15.

As viewed from a viewing position 24, the viewing bezel covers the external boundary 22 of the 2D image surface 18 and, if appropriate, a frame element 28 which is connected radially outwardly to the external boundary 22.

At this point it should be noted that the external frame element 28 can be a housing 28′ of an appliance (not shown), such as for example a mobile telephone, a mobile TV or DVD appliance, a PC display monitor or a stationary TV apparatus, which serves to represent the 2D image surface and to protect it against external influences.

It is, however, also conceivable that the external frame element 28 is merely a frame, in particular an image frame 28″, of the 2D image surface.

It is furthermore also conceivable that the 2D image surface 18 has no frame elements 28, but is present as an individual photo 18′. In this case, the viewing bezel 12 would merely cover the external boundary 22 of the 2D image surface 18.

For better illustration of the present invention in FIG. 1, the viewing field 15, as viewed from the viewing position 24, is formed by the opening 14 and allows the viewer a view onto an image section 38′ on the 2D image surface 18, wherein the viewing bezel 12 conceals the view onto the external frame element 28, as viewed from the viewing position 24, by its external boundary 34.

The distance 20 between the boundary 16 of the viewing bezel 12 delimiting the viewing field 15 and the 2D image surface 18 arranged behind it is approximately 2% to approximately 30% of a greatest extent 36 of the 2D image surface 18. In the present exemplary embodiment according to FIG. 1, for better illustration, no real relationship between the viewing bezel 12 and the 2D image surface 18 is illustrated.

The greatest extent 36 is understood to mean that distance on the 2D image surface 18 which is greatest between two points on the 2D image surface 18. On account of the rectangular shape of the 2D image surface 18, the greatest extent 36 in the present exemplary embodiment is accordingly the diagonal 36′.

The viewing position 24 is for example a seat in a room or a larger hall, from where the view onto the 2D image surface through the opening 14, in particular the boundary 16 delimiting the viewing field 15, of the viewing bezel 12 is made possible. It is advantageous here if, when viewing through the boundary 16 of the viewing bezel 12 delimiting the viewing field 15, only a limited image information item 38, in the sense of the image section 38′, on the 2D image surface 18 is perceived, without at the same time seeing the external boundary 22 of the 2D image surface 18 or, if appropriate, the frame element 28 connected radially outwardly to the external boundary 22.

This has the advantageous effect that, with appropriate use of the apparatus 10, as viewed from the viewing position 24, a detached space in front of the viewing bezel 12 in the direction of the 2D image surface 18 is produced, which corresponds to the spatial depth effect.

In contrast to the viewing apparatuses of the prior art as stated in the introductory part, the exact location of the 2D image surface 18 in the present invention, as viewed from the viewing position 24, in front of the viewing bezel 12 in the direction of the 2D image surface 18 is not perceived. As a result, double images, which the viewer would have to process, cannot be perceived as viewed from the viewing position 24. Instead, the detached space is produced if the distance between the boundary 16 of the viewing bezel 12 delimiting the viewing field 15 and the 2D image surface 18 arranged behind it is at least approximately constant.

For protection against external influences, the opening 14 of the viewing bezel 12 may be covered with a transparent material 40. Here, a glass pane 40′ could be used. The glass pane 40′ could preferably have antireflective coatings on both sides so as to avoid reflections on the glass pane 40′ from the 2D image surface 18 or the environment.

It should be noted in this context that the 2D image surface 18 in the installed state of the apparatus according to the invention and using the glass pane 40′ is closed off with respect to the environment and thus protected well.

In one preferred embodiment of the present invention, the glass pane 40′ can also be configured as a touch screen having robust properties. Accordingly, the outside of the glass pane 40′ facing the environment can be configured as a touch screen which is washable without difficulty.

The present invention further relates to an apparatus for producing a spatial depth effect of an image information item present in a 2D image surface, said apparaturs comprising
a viewing bezel (12) having an opening (14), wherein the viewing bezel (12) has a boundary (16) delimiting a viewing field (15) and the opening (14) forms the viewing field (15); and
a 2D image surface (18, 18′), arranged at a distance (20) behind the viewing bezel (12) and delimited by an external boundary (22) at the periphery, wherein the 2D image surface (18, 18′) is larger than the opening (14) of the viewing bezel (12); such that
with appropriate use, as viewed from a viewing position (24), the viewing bezel (12) conceals the external boundary (22) of the 2D image surface (18, 18′) and, if appropriate, a frame element (28, 28′, 28″) connected radially outwardly to the external boundary (22);

wherein the distance (20) between the boundary (16) of the viewing bezel (12) delimiting the viewing field (15) and the 2D image surface (18, 18′) arranged behind it is at least approximately constant.

The present invention further relates to a method for producing a spatial depth effect of an image information item present in a 2D image surface, having an apparatus as claimed in one of claims 1 to 10, comprising the following steps:

providing a viewing bezel (12) having an opening (14), wherein the viewing bezel (12) has a boundary (16) delimiting a viewing field (15) and the opening (14) forms the viewing field (15); and

arranging a 2D image surface (18, 18′) delimited at the periphery by an external boundary (22) at a distance (20) behind the viewing bezel (12), wherein the 2D image surface (18, 18′) is larger than the opening (14) of the viewing bezel (12); such that

with appropriate use of the apparatus, as viewed from a viewing position (24), the viewing bezel (12) conceals the external boundary (22) of the 2D image surface (18, 18′) and, if appropriate, a frame element (28, 28′, 28″) connected radially outwardly to the external boundary (22); and

there is an at least approximately constant distance (20) between the boundary (16) of the viewing bezel (12) delimiting the viewing field (15) and the 2D image surface (18, 18′) arranged behind it.

1-13. (canceled)

14. An apparatus for producing a spatial depth effect of an image information item present in a 2D image surface, comprising
a viewing bezel (12) having an opening (14), wherein the viewing bezel (12) has a boundary (16) delimiting a viewing field (15) and the opening (14) forms the viewing field (15); and
a 2D image surface (18, 18′), arranged at a distance (20) behind the viewing bezel (12) and delimited by an external boundary (22) at the periphery, wherein the 2D image surface (18, 18′) is larger than the opening (14) of the viewing bezel (12); such that
with appropriate use, as viewed from a viewing position (24), the viewing bezel (12) conceals the external boundary (22) of the 2D image surface (18, 18′) and, if appropriate, a frame element (28, 28′, 28″) connected radially outwardly to the external boundary (22);
wherein the distance (20) between the boundary (16) of the viewing bezel (12) delimiting the viewing field (15) and the 2D image surface (18, 18′) arranged behind it is at least approximately constant,
wherein the distance (20) between the boundary (16) of the viewing bezel (12) delimiting the viewing field (15) and the 2D image surface (18, 18′) arranged behind it is approximately 4% to approximately 20% of a greatest extent (36), in particular a diagonal (36′), of the 2D image surface (18, 18′).

15. The apparatus as claimed in claim 14, wherein the distance is approximately 8% to approximately 15%, of the greatest extent (36) of the 2D image surface (18, 18′).

16. The apparatus as claimed in claim 14, wherein the distance is approximately 10% of the greatest extent (36) of the 2D image surface (18, 18′).

17. The apparatus as claimed in claim 14, wherein the boundary (16) of the viewing bezel (12) delimiting the viewing field (15) is located on one plane.

18. The apparatus as claimed in claim 14, wherein the 2D image surface (18, 18′) has a flat configuration.

19. The apparatus as claimed in claim 14, wherein the boundary (16) of the viewing bezel (12) delimiting the viewing field (15) and the 2D image surface (18, 18′) are arranged such that they are parallel with respect to one another.

20. The apparatus as claimed in claim 14, wherein the opening (14), in particular the boundary (16) delimiting the viewing field (15), of the viewing bezel (12) and the external boundary (22) of the 2D image surface (18, 18′) are similar in terms of their shape.

21. The apparatus as claimed in claim 14, wherein the opening (14) of the viewing bezel (12) is covered with a transparent material (40).

22. The apparatus as claimed in claim 21, wherein the transparent material (40) is a glass pane (40′), in particular a glass pane (40′) with antireflective coatings on both sides.

23. A method for producing a spatial depth effect of an image information item present in a 2D image surface, having an apparatus as claimed in claim 1, comprising the following steps:
providing a viewing bezel (12) having an opening (14), wherein the viewing bezel (12) has a boundary (16) delimiting a viewing field (15) and the opening (14) forms the viewing field (15); and
arranging a 2D image surface (18, 18′) delimited at the periphery by an external boundary (22) at a distance (20) behind the viewing bezel (12), wherein the 2D image surface (18, 18′) is larger than the opening (14) of the viewing bezel (12); such that
with appropriate use of the apparatus, as viewed from a viewing position (24), the viewing bezel (12) conceals the external boundary (22) of the 2D image surface (18, 18′) and, if appropriate, a frame element (28, 28′, 28″) connected radially outwardly to the external boundary (22); and
there is an at least approximately constant distance (20) between the boundary (16) of the viewing bezel (12) delimiting the viewing field (15) and the 2D image surface (18, 18′) arranged behind it,
wherein by arranging the boundary (16) of the viewing bezel (12) delimiting the viewing field (15) with respect to the 2D image surface (18, 18′) arranged behind it at a distance (20) of approximately 4% to approximately 20% of a greatest extent (36), in particular a diagonal (36′), of the 2D image surface (18, 18′).

24. The method as claimed in claim 23, wherein by arranging the boundary (16) of the viewing bezel (12) delimiting the viewing field (15) with respect to the 2D image surface (18, 18′) arranged behind it at a distance (20) of approximately 8% to approximately 15%, of the greatest extent (36) of the 2D image surface (18, 18′).

25. The method as claimed in claim 23, wherein by arranging the boundary (16) of the viewing bezel (12) delimiting the viewing field (15) with respect to the 2D image surface (18, 18′) arranged behind it at a distance (20) of approximately 10% of the greatest extent (36) of the 2D image surface (18, 18′).

26. The method as claimed in claim 23, wherein by arranging the boundary (16) of the viewing bezel (12) delimiting the viewing field (15) such that it is parallel with respect to the 2D image surface (18, 18′).
